(19) United States
(12) Patent Application Publication
(10) Pub. No.: US 2019/0193689 A1
(43) Pub. Date: Jun. 27, 2019

(54) EFFICIENT WHEEL CLEANING SYSTEM FOR ACHIEVING ACCURATE TORQUE MEASUREMENT

(71) Applicants: Alexander J. Sacha, Park Ridge, IL (US); Charles Wright, Park Ridge, IL (US); Christopher Spinelli, Park Ridge, IL (US)

(72) Inventors: Alexander J. Sacha, Park Ridge, IL (US); Charles Wright, Park Ridge, IL (US); Christopher Spinelli, Park Ridge, IL (US)

(21) Appl. No.: 15/855,247

(22) Filed: Dec. 27, 2017

(51) Int. Cl. B60S 3/04; A46B 13/00; B08B 1/04

(52) U.S. Cl. CPC B60S 3/042; A46B 13/02; B08B 1/04; A46B 13/001

(57) ABSTRACT

The invention is a highly-efficient apparatus and system for removing impurities and debris from wheel components in a time-optimized and cost-controlled manner to ensure consistent results. The system is a single integrated tool on which employees can be quickly trained to perform all wheel cleaning functions by using the tool's components in any order, increasing the probability that all operations will be performed.

### FIELD OF INVENTION

This invention relates to the field of tooling and more specifically to tool for removing debris from wheel components to maintain metal-to-metal contact.

### BACKGROUND OF THE INVENTION

Wheel separations are viewed as preventable road events, provided that federal standard and industry guidelines are followed.

One of the common causes of wheel separation is a failure of the threaded wheel stud components. A minute amount of rust and debris will compromise the metal-to-metal contact essential for achieving proper clamping force. Clamping force is a function of friction at a metal-to-metal interface that restricts movement of the joined surfaces relative to one another. Clamping force cannot be measured directly, and is measured by torque. Torque must be applied within specified tolerances developed for metal-to-metal mating of clean components.

Once a wheel is installed, it not possible to visually inspect to determine if studs and rim components have been properly cleaned. However, automotive service providers who fail to implement proper technician training and supervision for component preparation processes and the wheel service process face stiff penalties. They are also held liable if the cause of an accident is attributed to improper cleaning and preparation of stud and rim components necessary to maintain essential metal-to-metal contact and achieve substantial clamping force.

Minute amounts of rust or debris can cause fastening components to deliver dramatically different clamping forces and prevent compliant torque measurement, contributing to wheel separation.

An improper seal between the wheel hub and rim is also a common cause of wheel separation. OSHA Standard No. 3086 mandates that all “[r]im flanges, rim gutters, rings, and the bead-seating areas of wheels must be free of any dirt, surface rust, scale, or loose or flaked rubber buildup prior to tire mounting and inflation.” The presence of non-metal impurities on rims and/or wheel hubs interferes with the clamping force between the wheel hub and rim.

Numerous wheel cleaning tools and kits are known in the art. However, multiple tools must be used separately to complete cleaning essential for wheel installation. The technician must select and switch tools during a cleaning operation, increasing labor time and producing inconsistent results which are not amenable to inspection.

There is an unmet need for an integrated wheel cleaning system and apparatus which may be used to optimize time and consistently control the quality and efficiency of wheel cleaning operations to assure compliance with OSHA, DOT, and industry standards.

### SUMMARY OF THE INVENTION

The invention is a highly-efficient apparatus and system for removing impurities and debris from wheel components in a time-optimized and cost-controlled manner to ensure consistent results. The system is a single, integrated tool on which employees can be quickly trained to perform all wheel cleaning functions by using the tool's components in any order, increasing the probability that all operations will be performed.

The tool is specifically configured to efficiently clean hubs, rims, studs and other wheel related components, consistent with OSHA Standard No. 3086, Department of Transportation and other industry regulations, and manufacturer specified guidelines.

The invention is comprised of a cylindrical stud cleaning column with an upper column surface and a lower column surface, an abrasive pad assembly having a first aperture adapted to receive a stud, a housing comprised of a base portion having a tool receiving interface and a head portion having an upper head surface with a second aperture to receive the stud, wherein the head portion is further adapted to enclose the cylindrical stud cleaning column.

### BRIEF DESCRIPTION OF THE DRAWINGS

FIGS. 1a and 1b illustrate an isometric view and a side view of an automotive cleaning apparatus in use for removing residue from a wheel stud and hub.

FIG. 2 illustrates a sectional side view of an automotive cleaning apparatus in use for removing residue from a wheel stud.

FIG. 3 is an exploded view of an automotive cleaning apparatus.

FIG. 4 illustrates multiple perspective views of a base component of an automotive cleaning apparatus.

FIG. 5 illustrates multiple perspective views of a cylindrical stud cleaning column component of an automotive cleaning apparatus.

FIG. 6 illustrates multiple perspective views of a head component of an automotive cleaning apparatus.

FIG. 7 illustrates multiple perspective views of an abrasive pad assembly of an automotive cleaning apparatus.

### TERMS OF ART

As used herein, the term “aperture” means an opening, hole, or gap in an object.

As used herein, the term “assembly” means a combination of one or more components.

As used herein, the term “attachment interface” means a physical point on a feature to facilitate contact, joining and/or attachment between two or more components.

As used herein, the term “tine” means an elongated body, which may include a prong or an antler, and may have a sharp point at one end.

### DETAILED DESCRIPTION OF THE INVENTION

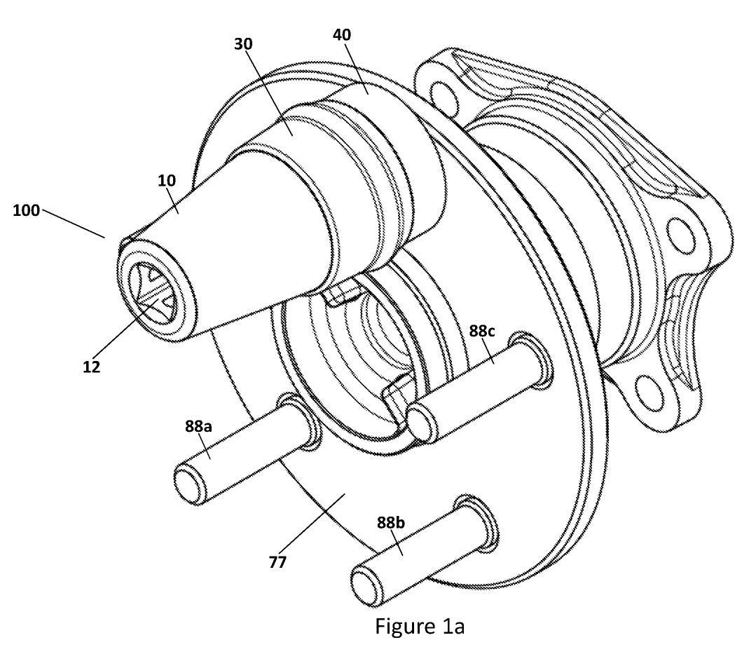

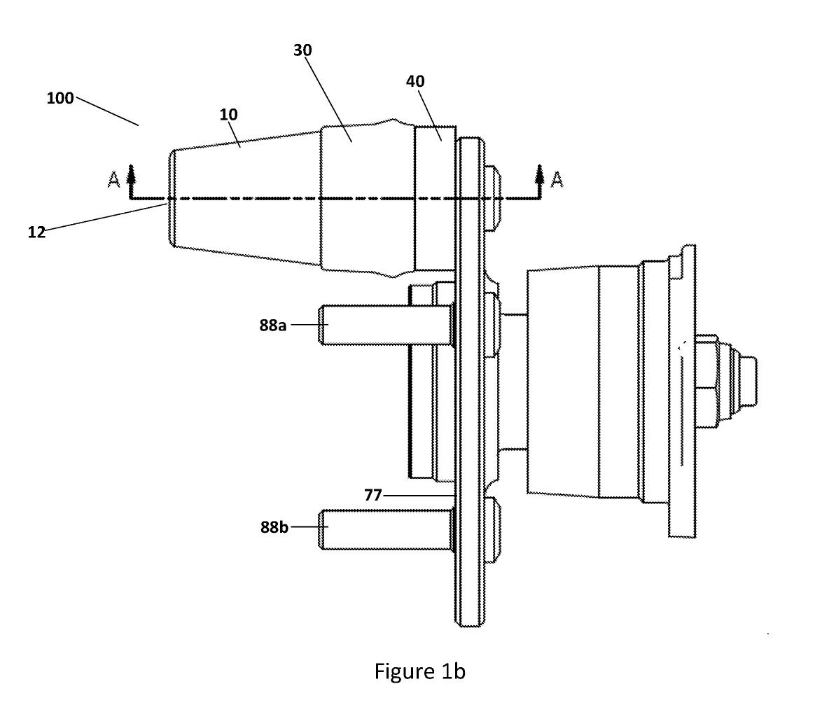

FIGS. 1a and 1b illustrate an isometric view and a side view of automotive cleaning apparatus 100 in use for removing residue from a wheel stud and hub.

FIGS. 1a and 1b illustrate automotive cleaning apparatus 100, which is used to concurrently clean stud 88 and wheel hub face 77.

Automotive cleaning apparatus 100 includes base 10, cylindrical stud cleaning column 20, head 30, and abrasive pad assembly 40.

In the exemplary embodiment shown, base 10 includes a mechanical or connective interface 12 for operatively coupling with a drill or other rotational tool. During operation, cylindrical stud cleaning column 20 is housed within head 30. Head 30 is fixedly or removably attached to base 10 to form a housing for cylindrical stud cleaning column 20. Abrasive pad assembly 40 is fixedly or removably attached to the upper surface of head 30 and rotates during operation.

Cylindrical stud cleaning column 20 rotates during operation to clean the internal and external thread diameters of threaded studs 88.

Abrasive pad assembly 40 and cylindrical stud cleaning column 20 rotate concurrently to concurrently clean stud 88 and wheel hub face 77.

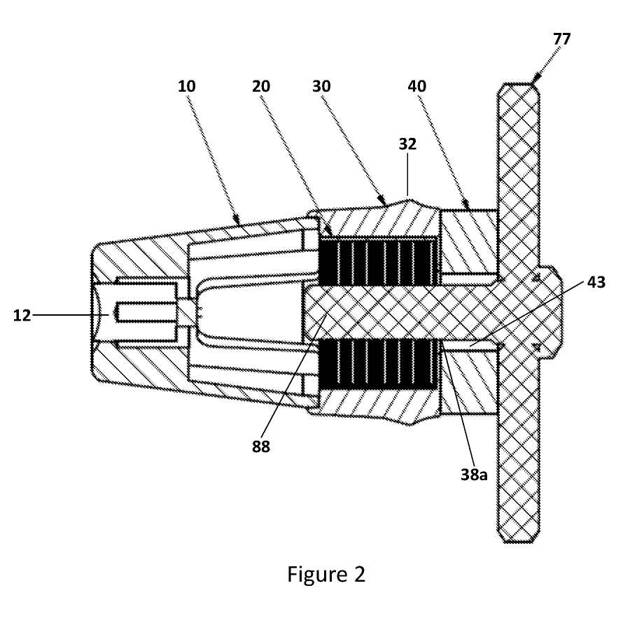

FIG. 2 illustrates a sectional side view of automotive cleaning apparatus 100 in use for removing residue from a wheel stud.

In the exemplary embodiment shown, when automotive cleaning apparatus 100 is in use, cleaning interface 41a of abrasive pad assembly 40 cleans wheel hub face 77 and stud 88 can slide through central aperture 43 of abrasive pad assembly 40, which has a circumference that is larger than the largest circumference of stud 88, to allow cylindrical stud cleaning column 20 to contact and clean stud 88. Stud 88 can slide through stud aperture 38b in head 30 to allow inner stud column surface 21a to contact and clean stud 88.

In the exemplary embodiment shown, bumper 32 has a circumference that is larger than the circumference of abrasive pad assembly 40 to protect the outer edge of abrasive pad assembly 40 from contacting stud 88 when automotive cleaning apparatus 100 is in use to clean wheel hub face 77 between studs 88; this prevents unnecessary degradation of abrasive pad 40. In the exemplary embodiment shown, bumper 32 does not contact abrasive pad assembly 40. In alternative embodiments, bumper 32 may receive and encircle or encompass lower surface 41b of abrasive pad assembly 40.

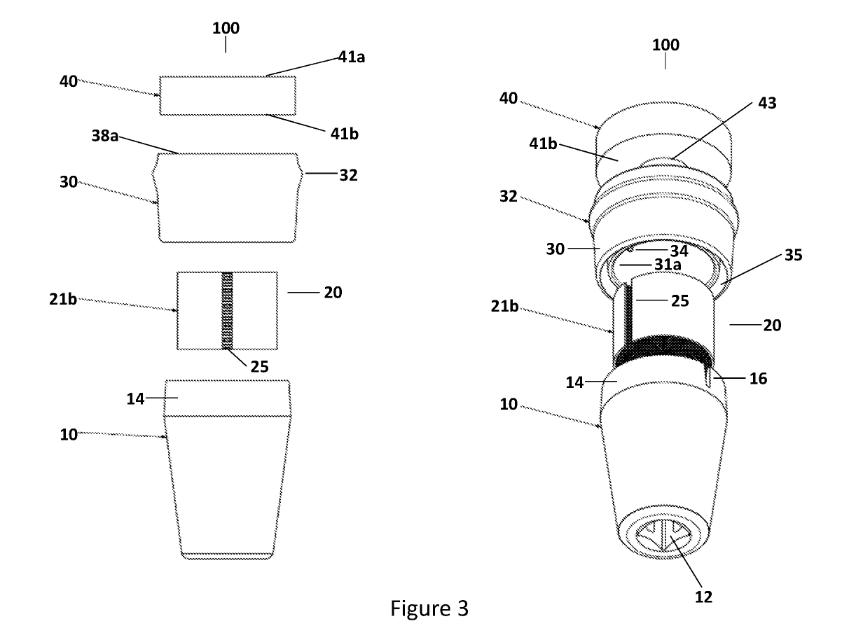

FIG. 3 is an exploded view of automotive cleaning apparatus 100, which includes base 10, cylindrical stud cleaning column 20, head 30, and abrasive pad assembly 40.

FIG. 3 shows base 10, bottom surface with rotational tool-receiving interface 12, upper base rim edge 14, slot 16, cylindrical stud cleaning column 20, outer stud column surface 21b, vertical space between ends 25, head 30, inner head surface 31a, bumper 32, vertical protuberance 34, circular rim channel 35, upper surface 38a, abrasive pad assembly 40, cleaning interface 41a, lower surface 41b, and central aperture 43.

In various alternative embodiments, alternative corresponding geometry may be used to secure base 10 to head 30 and cylindrical stud cleaning column 20.

In the exemplary embodiment shown, cylindrical stud cleaning column 20 slides within inner head surface 31a of head 30 such that vertical protuberance 34 of head 30 fits within vertical space between ends 25 of cylindrical stud cleaning column 20. Outer stud column surface 21b contacts inner head surface 31a. In various embodiments, glue, epoxy, or another adhesive secures outer stud column surface 21b to inner head surface 31a.

In alternative embodiments, base 10 and head 30 may have alternative complementary geometry that allows base 10 to fixedly or removably attach to head 30.

In alternative embodiments, base 10 and head 30 may be one integrally molded piece adapted to receive cylindrical stud cleaning column 20 and abrasive pad assembly 40.

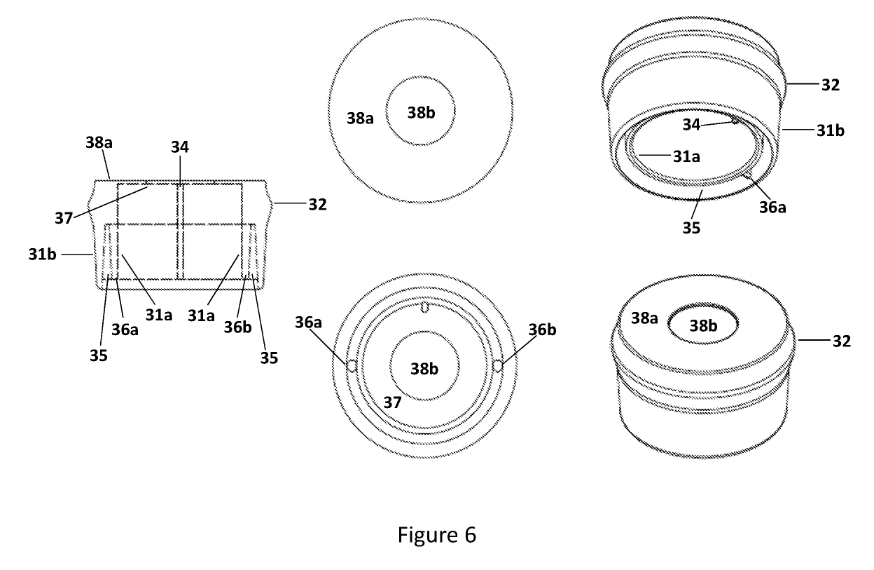

In the exemplary embodiment shown, upper base rim edge 14 inserts into circular rim channel 35. Slot 16 is adapted to receive plurality of geometric components 36 (not shown, see FIG. 6) of head 30. In various embodiments, glue, epoxy, or another adhesive secures upper base rim edge 14 to circular rim channel 35.

In the exemplary embodiment shown, upper surface 38a of head 30 attaches to lower surface 41b of abrasive pad assembly 40. In various embodiments, glue, epoxy, or another adhesive substance or mechanical attachment (e.g. screws, bolts) may secure upper surface 38a to lower surface 41b.

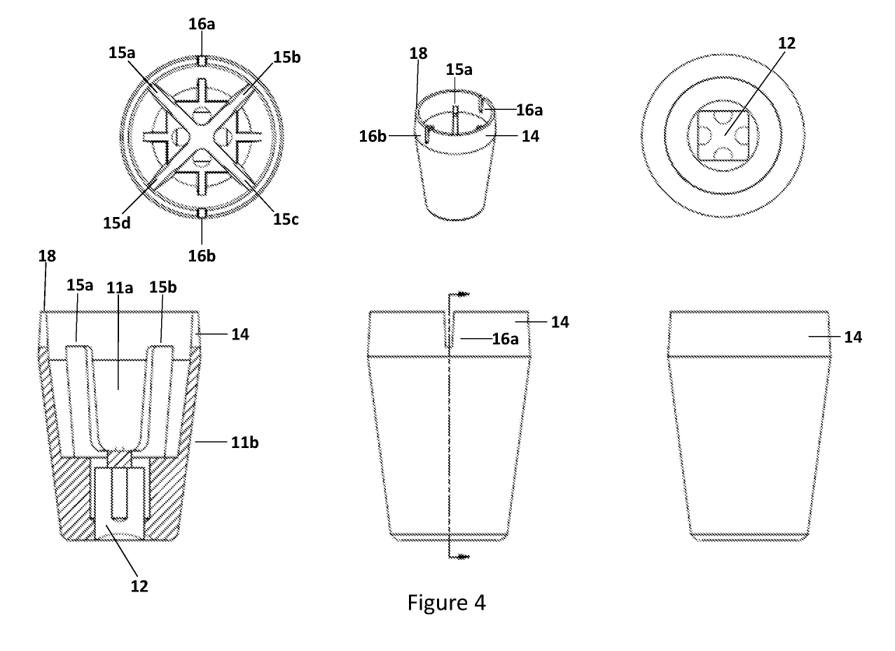

FIG. 4 illustrates multiple perspective views of base component 10 of automotive cleaning apparatus 100.

In the exemplary embodiment shown, base 10 includes base inner surface 11a, base outer surface 11b, bottom surface with drill receiving interface 12, upper base rim edge 14, vertical strut ends 15a-d, slots 16a and 16b, and open ended top surface 18.

In the exemplary embodiment shown, bottom surface with drill receiving interface 12 is adapted to receive a rotational tool, which may be a drill. In alternative embodiments, bottom surface with drill-receiving interface 12 includes a hex shank or round shank.

In the exemplary embodiment shown, when base 10 inserts into head 30, vertical strut ends 15a-d contact the bottom of rectangular plastic layer 22 and the bottom edge of inner surface 31a. This prevents stud cleaning column 20 from sliding into base 10. Vertical strut ends 15a-d extend from base inner surface 11a far enough to contact rectangular plastic layer 22 without interfering with the movement of plurality of tines 23a-n.

In various embodiments, base 10 may have one or more slots 16.

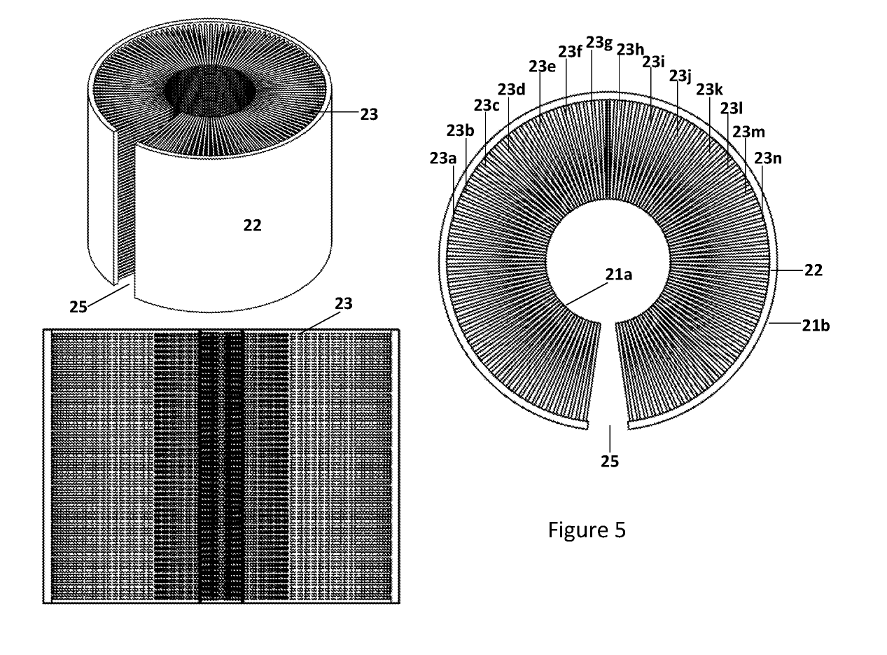

FIG. 5 illustrates multiple perspective views of cylindrical stud cleaning column component 20 of automotive cleaning apparatus 100.

In the exemplary embodiment shown, cylindrical stud cleaning column 20 is comprised of plurality of tines 23a-n inserted in rectangular plastic layer 22, curved into a cylinder such that the free ends of tines 23a-n form inner stud column surface 21a, rectangular plastic layer 22 forms outer stud column surface 21b, and the ends of rectangular plastic layer 22 do not touch, forming vertical space between ends 25.

In alternative embodiments, the ends of rectangular plastic layer 22 do touch and there is no vertical space between ends 25.

In alternative embodiments, cylindrical stud cleaning column 20 is manufactured as a cylinder and does not need to be rolled to form a cylinder.

In the exemplary embodiment shown, rectangular plastic layer 22 is flexible and the plastic will not melt from the heat caused by rotational friction of tines 23a-n during operation of automotive cleaning apparatus 100.

In the exemplary embodiment shown, one end of each tine 23a-n is inserted through rectangular plastic layer 22 approximately 0.5-4 mm apart and the inserted end is bent to secure the tine to the plastic. The spacing of tines 23a-n optimizes the amount of contact with stud 88 and avoids deforming or binding of the tines during use. The distance between rectangular plastic layer 22 and the unsecured ends of tines 23a-n is approximately 0.3 inches long.

In the exemplary embodiment shown, inner stud column surface 21a has a diameter of approximately 0.245-1.48 inches to clean stud 88. Inner stud column surface 21a has a diameter that allows plurality of tines 23a-n to contact and clean the internal and external thread diameters of car studs (which have an external diameter of approximately ¼-⅝″) and/or truck studs (which have an external diameter of approximately ½-1.5″). In alternative embodiments, inner stud column surface 21a has a diameter adapted to clean studs with a diameter that is not listed here.

In the exemplary embodiment shown, tines 23a-n extend in straight lines, perpendicularly from rectangular plastic layer 22. In alternative embodiments, plurality of tines 23a-n may face in various directions, erratically. In alternative embodiments, each of tines 23a-n may be bent between its free end and its interface with rectangular plastic layer 22.

In alternative embodiments, plurality of tines 23a-n may be replaced by another type of cleaning component including, but not limited to, bristles, paper, fabric, resin, fibers, rubber, flexible protuberances, and inflexible protuberances.

In various embodiments, cylindrical stud cleaning column 20 is removable, disposable and/or replaceable.

FIG. 6 illustrates multiple perspective views of head component 30 of automotive cleaning apparatus 100.

In the exemplary embodiment shown, head 30 includes inner head surface 31a, outer head surface 31b, bumper 32, vertical protuberance 34, circular rim channel 35, plurality of geometric components 36a and 36b, inner ledge 37, upper surface 38a, and stud aperture 38b.

In the exemplary embodiment shown, cylindrical stud cleaning column 20 slides within inner head surface 31a of head 30 such that vertical protuberance 34 of head 30 fits within vertical space between ends 25 of cylindrical stud cleaning column 20. Outer stud column surface 21b contacts inner head surface 31a. In various embodiments, glue, epoxy, or another adhesive secures outer stud column surface 21b to inner head surface 31a.

In the exemplary embodiment shown, circular rim channel 35 is located between inner head surface 31a and outer head surface 31b. Upper base rim edge 14 of base 10 slides into circular rim channel 35. Slots 16a and 16b receive plurality of geometric components 36a and 36b. In various embodiments, glue, epoxy, or another adhesive is applied to rim channel 35 and plurality of geometric components 36 to secure base 10 to head 30.

In various embodiments, head 30 may have a number of geometric components 36 that is equal to or less than the number of slots 16.

In the exemplary embodiment shown, upper surface 38a attaches to abrasive pad assembly 40. Stud aperture 38b has a circumference larger than the circumference of stud 88 to allow stud 88 to pass through stud aperture 38b.

In the exemplary embodiment shown, inner ledge 37 is in contact with upper surface 38a and prevents cylindrical stud cleaning column 20 from sliding out of head 30.

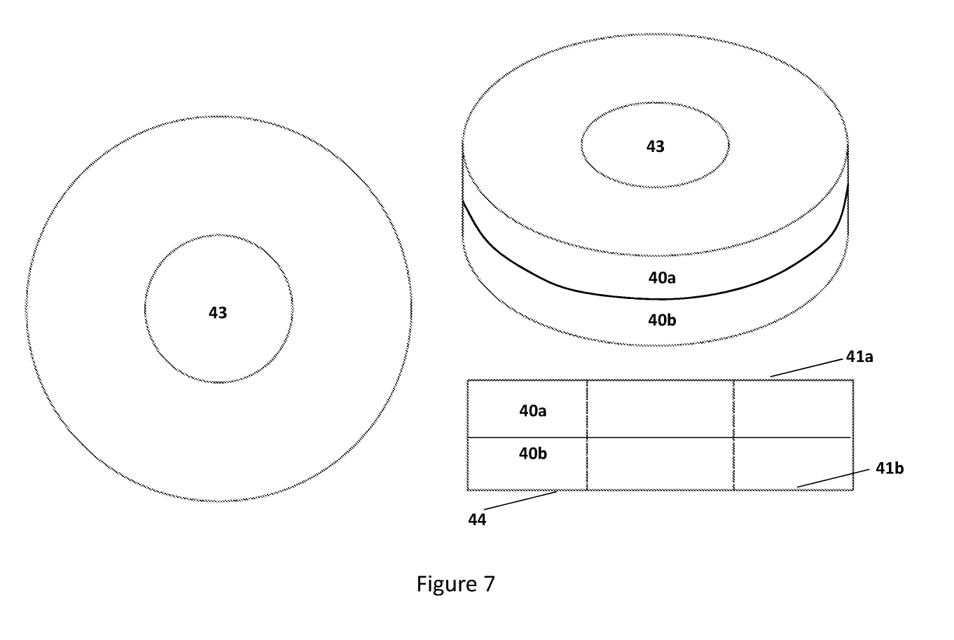

FIG. 7 illustrates multiple perspective views of abrasive pad assembly 40 of automotive cleaning apparatus 100.

In various embodiments, abrasive pad assembly 40 includes first pad layer 40a, second pad layer 40b, cleaning interface 41a, lower surface 41b, pad adhesive layer 44, and central aperture 43.

In the exemplary embodiment shown, cleaning interface 41a contacts and cleans wheel hub face 77.

In various embodiments, pad adhesive layer 44 secures lower surface 41b to upper surface 38a of head 30. In alternative embodiments, lower surface 41b may be secured to upper surface 38a by other means.

In the exemplary embodiment shown, one or more pad layers 40a-b are created by heating a quantity of nylon polymer, spraying the nylon polymer into the proper shape, allowing it to harden, adding grit to a resin, then adding it to the pad layers, and heating the pad layers to approximately 400° F. and compressing them to create a high-density, compressed, non-woven nylon material. Multiple layers can be combined by stacking the layers, heating them to approximately 400° F., and pressing them.

In various embodiments, abrasive pad assembly 40 may include one or multiple pad layers. In various embodiments, abrasive pad assembly 40 may be comprised of many different grit materials, including aluminum oxide or silicon carbide.

In various embodiments, abrasive pad assembly 40 is removable, disposable and/or replaceable.

What is claimed is:

1. A wheel component cleaning apparatus comprised of:
a cylindrical stud cleaning column having an interior surface;
an abrasive pad assembly having an abrasive circular surface and an aperture adapted to receive a stud; and
wherein said cylindrical stud cleaning column and said abrasive pad assembly are operatively coupled to produce rotational movement to remove debris from said stud and clean a portion of the surface of a wheel hub during a first time period, and clean the remaining hub surface during a second time period and to clean a wheel rim.

2. The wheel component cleaning apparatus of claim 1 which further includes a housing comprised of:
a tool receiving interface for operatively coupling said cylindrical stud cleaning column to a power tool capable of producing rotational movement controlled by a user.

3. The wheel component cleaning apparatus of claim 2, wherein said housing substantially encloses said cylindrical stud cleaning column and which maintains the position of said cylindrical stud cleaning column.

4. The wheel component cleaning apparatus of claim 3, wherein said housing further includes:
a base portion; and
a head portion having an upper head surface configured with an aperture to receive said stud;
wherein said head portion is further adapted to enclose said cylindrical stud cleaning column.

5. The apparatus of claim 4 wherein an inner surface of said head portion of said housing further includes a vertical protuberance on said inner surface to secure said cylindrical stud cleaning column.

6. The apparatus of claim 4 wherein an inner surface of said head portion of said housing further includes a circular protuberance on said inner surface to secure said cylindrical stud cleaning column.

7. The apparatus of claim 1 wherein said cylindrical stud cleaning column is a cylindrical column having an outer surface and an inner stud column surface, wherein said inner stud column surface is comprised of cleaning components selected from a group consisting of tines, bristles, paper, fabric, resin, fibers, rubber, flexible protuberances, and inflexible protuberances.

8. The apparatus of claim 1 wherein said cylindrical stud cleaning column is comprised of a rectangular plastic layer curved into a cylinder.

9. The apparatus of claim 8 which further includes a plurality of movable tines affixed to the inner surface of said rectangular plastic layer.

10. The apparatus of claim 9 wherein said plurality of movable tines are in contact with the internal and external thread diameters of said stud during use.

11. The apparatus of claim 2 wherein said housing is one integrally molded piece.

12. The apparatus of claim 4 wherein said base portion is selectively attachable to said head portion.

13. The apparatus of claim 9 wherein said plurality of movable tines are angularly displaced when in contact with the internal and external thread diameters of said stud.

14. The apparatus of claim 13 wherein one end of each of said plurality of movable tines is bent to secure each of said plurality of movable tines to said rectangular plastic layer of said cylindrical stud cleaning column.

15. The apparatus of claim 7 wherein said cylindrical stud cleaning column has an inner stud column surface with a diameter of approximately 0.24-1.5 inches.

16. The apparatus of claim 7 wherein said cylindrical stud cleaning column has an inner stud column surface with a diameter of approximately 0.24-0.64 inches.

17. The apparatus of claim 7 wherein said cylindrical stud cleaning column has an inner stud column surface with a diameter of approximately 0.5-1.5 inches.

18. The apparatus of claim 1 wherein said abrasive pad assembly includes at least one layer of abrasive material selected from a group consisting of nylon polymer, oil based resin, aluminum oxide, and silicon carbide.

19. The apparatus of claim 1 wherein said abrasive pad assembly is comprised of nylon resin which had been concurrently heated and compressed.

20. The apparatus of claim 1, wherein said abrasive pad assembly and said cylindrical stud cleaning column are selectively attached to allow replacement of said abrasive pad assembly and said cylindrical stud cleaning column.
